(19) United States
(12) Patent Application Publication
(10) Pub. No.: US 2014/0071493 A1
(43) Pub. Date: Mar. 13, 2014

(54) IMAGE FORMING APPARATUS AND IMAGE OUTPUT MANAGEMENT SYSTEM

(71) Applicants: TOSHIBA TEC KABUSHIKI KAISHA, Tokyo (JP); KABUSHIKI KAISHA TOSHIBA, Tokyo (JP)

(72) Inventor: Yuuichi Akiyama, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/901,744

(22) Filed: May 24, 2013

(30) Foreign Application Priority Data
Sep. 13, 2012 (JP) 2012-202021

(51) Int. Cl. G06K 15/02

(52) U.S. Cl. CPC G06K 15/1886
USPC 358/1.16

(57) ABSTRACT

In accordance with an embodiment, an image forming apparatus includes a storage unit, a control unit, an image forming section and a notification unit. The storage unit configured to keep a job that is input and designated a print start timing in a printable state. The control unit configured to accept a print start instruction. The image forming section configured to execute an image forming corresponding to the job stored in the storage unit according to the print start instruction from the control unit. The notification unit configured to notify the execution of the job.

### CROSS-REFERENCE TO RELATED APPLICATION

This application is based upon and claims the benefit of priority from Japanese Patent Application No. 2012-202021, filed Sep. 13, 2012, the entire contents of which are incorporated herein by reference.

### FIELD

Embodiments described herein relate to an image forming apparatus and an image output management system.

### BACKGROUND

“Print start timing designation” mode in which a user can designate a timing to output an output image (print out) has been put to practical use in an image forming apparatus (Multi-Functional peripheral, MFP).

### BRIEF DESCRIPTION OF THE DRAWINGS

FIG. 1 illustrates an example of an image forming apparatus and a network according to one embodiment;

FIG. 2 illustrates an example of an image forming apparatus according to the embodiment;

FIG. 3 illustrates an example of the operation of an image forming apparatus according to the embodiment.

### DETAILED DESCRIPTION

In accordance with an embodiment, an image forming apparatus includes a storage unit, a control unit, an image forming section and a notification unit. The storage unit configured to keep a job that is input and designated a print start timing in a printable state. The control unit configured to accept a print start instruction. The image forming section configured to execute an image forming corresponding to the job stored in the storage unit according to the print start instruction from the control unit. The notification unit configured to notify the execution of the job.

Hereinafter, the embodiments are described with reference to the drawings.

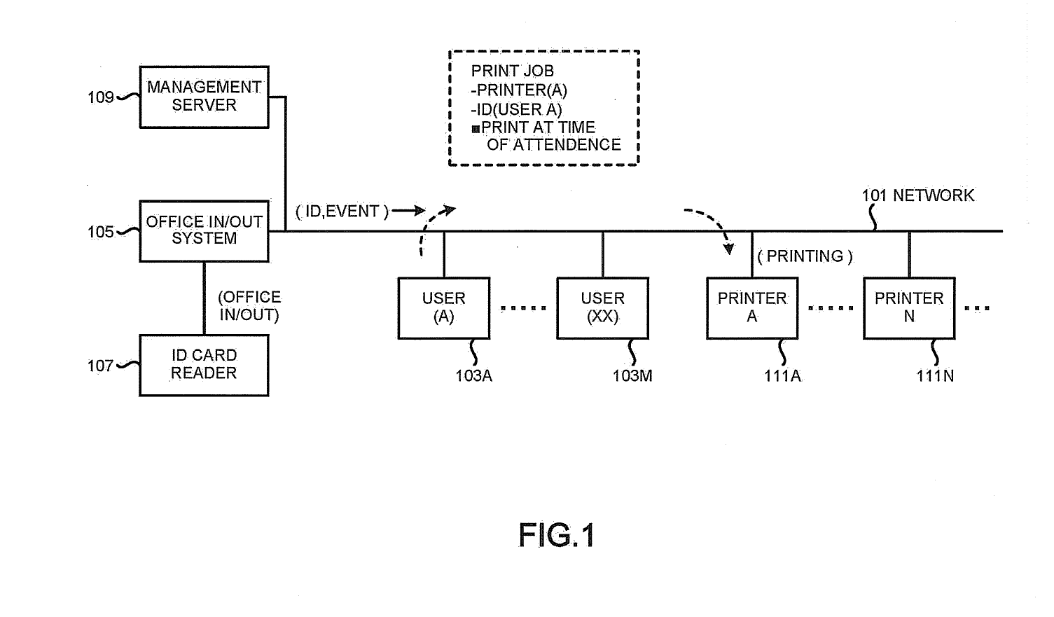

In FIG. 1, any number of electronic devices (MFP, Multi-Functional Peripheral, namely image forming apparatus) 111A, 111B, . . . , 111N (N is a positive integer) are located on a network 101.

Also, any number of users such as user 103A, user 103B, . . . , and user 103M (M is a positive integer) are connected with the network 101. In addition, each user is, for example, a personal computer (PC, Personal Computer) and the like.

Also, a office in/out system 105, an ID card reader 107 inputting the attendance (entrance) of the user into the office in/out system 105 and a management server 109 are connected with the network 101.

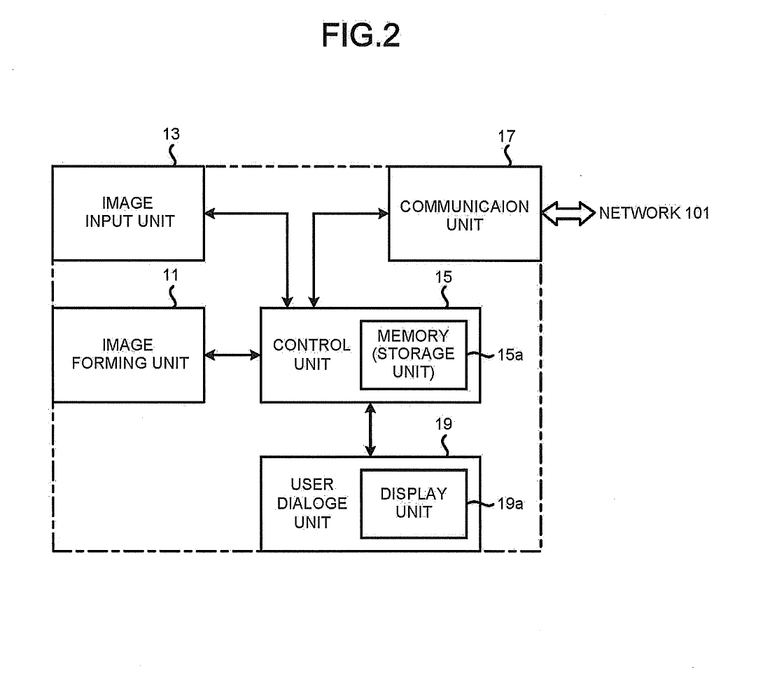

Each of the image forming apparatuses 111A, 111B, . . . and 111N, for example as shown in an example in FIG. 2, includes a printer section 11, a scanner section 13, a control section 15, an interface section 17, a user interface section 19 and the like. In addition, the control section 15 has a main control apparatus, i.e. CPU (Central Processing Unit) or MPU (Main Processing Unit), and a primary storage apparatus (main memory or working memory, storage section) integrally (as a firmware) or as external units.

In addition, the user interface section 19 displays information such as a printout (print output) (or “output after a few minutes”) of the “print at time of attendance” instructed by a user previously, for example, when leaves off work the day before, according to user authentication information on the network 101, for example, the user input his entrance (attendance) into the office in/out system 105 (by holding the ID card over an ID card reader 107 and notifying the attendance to a management server 109).

The management server 109 is connected with each of the connected image forming apparatuses 111A, 111B, . . . , 111N, the users 103A, 103B, . . . , 103M, the office in/out system 105 and the ID card reader 107 via the network 101, and accepts the “print at time of attendance” job (print start) for any image forming apparatus from any user, and recognizes the user's attendance with the ID card reader 107, and executes the “print at time of attendance” job.

That is, the management server 109 acquires the condition that, for example, the “print at time of attendance” job is input (instructed) into the image forming apparatus 111A by the user 103A when leaves off work, next, in the next morning or at the attendance after a holiday, when the user 103A inputs entrance (attendance) with the ID card reader 107 into the office in/out system 105, the execution of the “print at time of attendance” job is instructed by the user 103A to the image forming apparatus 111A. Also, information of “printout is finished(or “output after a few minutes”) is fed back to a user terminal (in this case, the user 103A) via the server 109, and preferably, the existence of the printout item is notified by displaying on the screen, for example, the popup window on startup.

In this way, the user who is instructed “print at time of attendance” from the user 103A, on the condition that the user outputs a printout (print output) of the instructed “print at time of attendance” to the image forming apparatus 111A when leaves off work, can collect the printout (print output). In this case, the printout is executed when the user almost arrives nearby the image forming section, at the time just before arriving, or within a short period of time after arriving, thus the printout can be inhibited from being placed visibly for anyone else other than the user designating the print as far as possible.

In addition, even if the user forgets to instruct the “print at time of attendance”, in the image forming apparatus recording the “print at time of attendance” job, as described above, the print output being printed can be collected directly from the image forming apparatus 111A by notifying the user (103A) that there is a print output. In this way, the printout can be inhibited from being placed visibly for a third person other than the user designating the print as far as possible.

More particularly, the user (103A), when sending a printing job, sets the “print at time of attendance”, and sends the job to a printer (image forming apparatus) 111A. The printer 111A carries out a raster image processing for the sent job (RIP, Raster Image Processor) , and stores the processed job in a page memory or a specified storage section in the form of immediately printable data.

In the stored print job, at a time point when the attendance of the user (103A) whose ID of which is contained in job affiliation information, that is, the user who inputs his entrance (attendance) into the ID card reader 107 with the ID card is recognized (determined) by office in/out system 105 using the management server 109, whether there is a job for the user or not and whether there is a setting related to print timing or not is determined in the printer 111A using the instruction of the management server 109. That is, in the printer 111A, if there is a setting of “print at time of attendance” by the user (103A), the print of the stored job is executed. With the configuration (“print at time of attendance” system) above, the printing of the print (image output) stored when the user leaves out is started at the attendance time of the user, therefore, it is possible to prevent a problem such that anyone else see the printout (printed matter).

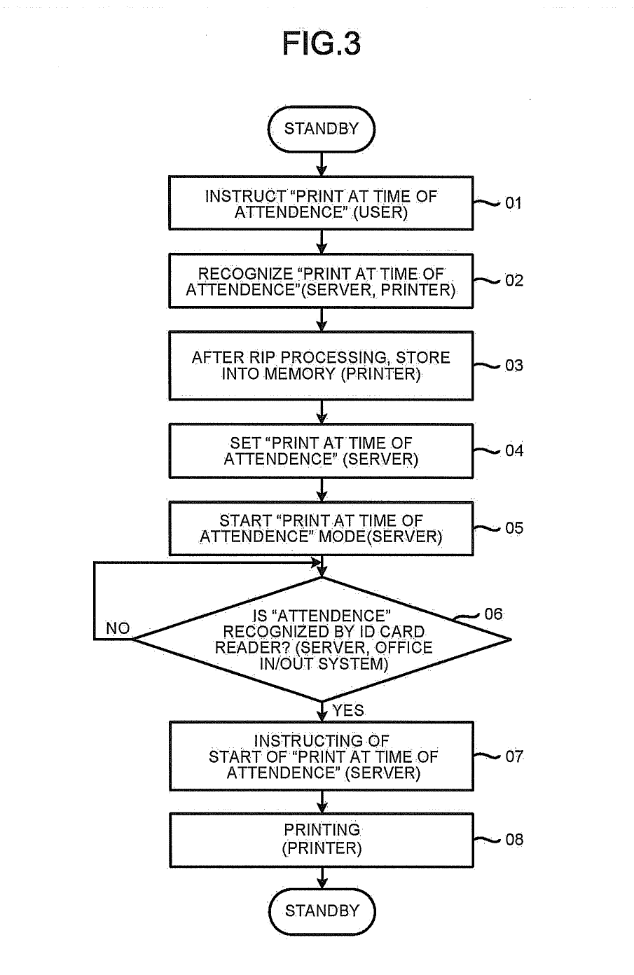

A summary of the above-mentioned “print at the time of attendance” is shown in FIG. 3.

In a case where any user instructs a printout (print output) of the set “print at time of attendance” (ACT01), the existence of a “print at time of attendance” (“print at time of attendance” is set) is notified to the management server 109 and the designated image forming apparatus (for example, a printer) 111A (ACT02).

The printer 111A carries out a raster image processing for the received job (RIP, Raster Image Processor) and stores the processed job in a page memory or a specified storage section in the form of immediately printable data (ACT03).

The management server 109 receives the attendance of the user serving as “print at time of attendance” (ACT04) to confirm the entrance of the user inputting entrance (attendance) into the office in/out system 105(by holding the ID card over the ID card reader 107 and notifying the attendance to the management server 109), and monitors the entrance (attendance) of the user by taking the existence of “print at time of attendance” as a detection flag, for example, a firmware or an internal program, so as to set for example a job detection mode such as “print at time of attendance” (ACT05).

Hereinafter, in a “print at time of attendance” job detection mode, the input of the entrance (attendance) by the user holding the ID card over the ID card reader 107 is detected (Yes in ACT06), and the instruction of “print at time of attendance” is sent to the instructed printer (image forming apparatus) 111A (ACT07).

In this way, the user (owner of user PC103A) executes a print (print output) of the set “print at time of attendance”, when, or before, or after the user passes the nearby printer (image forming apparatus) 111A, the user only waits for a little given time to execute “print at time of attendance” (ACT08).

In this way, when the user (owner of any user PC) is determined to come into office (attendance or entrance) by the office in/out system, the print job (print output) designated by “print at time of attendance” stored in the designated printer (image forming apparatus) when the same user leaves off work, thus the print (printout) can be inhibited from being placed in a state visible to a third person.

Also, the user, when starting the PC, is notified of the execution (in execution) (via the management server) of the designated print job designating “print at time of attendance”, thus even if the user forgets the printout designating the “print at time of attendance”, the print (printout) can be collected directly, thus can minimize the time period in a state invisible to a third person.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a storage unit configured to keep a job that is input and designated a print start timing in a printable state;
a control unit configured to accept a print start instruction;
an image forming section configured to execute an image forming corresponding to the job stored in the storage unit according to the print start instruction from the control unit; and
a notification unit configured to notify the execution of the job.

2. The image forming apparatus according to claim 1, wherein
the image forming section executes the image formation corresponding to the job stored in the storage unit according to the print start instruction from the control unit based on the input that a user is nearby.

3. The image forming apparatus according to claim 2, wherein
the control unit acquires the input that a user is nearby through a network.

4. The image forming apparatus according to claim 1, wherein
the network is an office in/out system.

5. An image output management system, comprising:
a storage unit configured to keep a job that is input and designated a print start timing in a printable state;
a control unit configured to accept a print start instruction;
an image forming section configured to execute an image forming corresponding to the job stored in the storage unit according to the print start instruction from the control unit; and
an instruction unit configured to instruct the print start to the control unit.

6. An image output management system according to claim 5, wherein
the instruction unit instructs the print start to the control unit when the user instructing the job is nearby the image forming section, at the timing of arriving nearby the image forming section, or within a specified time period after arriving nearby the image forming section.
